(19) United States
(12) Patent Application Publication
(10) Pub. No.: US 2005/0105889 A1
(43) Pub. Date: May 19, 2005

(54) Video picture compression artifacts reduction via filtering and dithering

(76) Inventor: Gregory J Conklin, Seattle, WA (US)

Correspondence Address: SCHWABE, WILLIAMSON & WYATT, P.C., 1211 SW FIFTH AVENUE, SUITES 1600-1900, PORTLAND, OR, 97204, US

(21) Appl. No.: 10/508,568

(22) PCT Filed: Mar. 12, 2003
(86) PCT No.: PCT/US03/07472

Related U.S. Application Data
(60) Provisional application No. 60/367,075, filed on Mar. 22, 2002.

(51) Int. Cl. H04N 5/781

(52) U.S. Cl. 386/95; 386/125

(57) ABSTRACT

A video apparatus is provided with the capability to dither one or more pixels across common block edges of adjacent pixel blocks of a picture where encoding/decoding are performed on a block based manner. In various embodiments, the adjacent pixel block may be coincident on macroblock boundaries, motion compensation block boundaries, transform block boundaries, or other block boundaries of the like. The dithering may be performed as part of the deblocling filtering operation or afterwards. The dithering values may be pre-computed and provided to the video apparatus or computed in real time.

### RELATED APPLICATION

This application is a non-provisional application of provisional application No. 60/367,075, filed Mar. 22, 2002, “Dithered RV9 In-Loop Deblocking Filter”, which specification is hereby fully incorporated by reference.

### FIELD OF THE INVENTION

The present invention relates to the field of video encoding/decoding. More specifically, the present invention is related to the reduction of compression artifacts in video pictures resulted from block based encoding/decoding of the video pictures.

### BACKGROUND OF THE INVENTION

Advances in microprocessor and video related technologies have led to wide spread deployment and adoption of numerous types of video devices. Examples of such video devices include but are not limited to digital camcorders, digital versatile disk (DVD) players, video enabled laptop and desktop computing devices as well as servers, and so forth.

Advances in networking, telecommunication, satellite and other related technologies have also led to increase in on demand and/or real time online delivery of video, including delivery over public networks, such as the Internet.

Whether videos are delivered offline (e.g. from a DVD player) or online (e.g. from a video server), high quality video inherently requires a high volume of data. Thus, video delivery and rendering often involve encoding and decoding to reduce the amount of data to be stored, retrieved and/or transmitted.

Encoding/decoding of a video often involves processing the video as a stream of pictures and in a block based manner. Each picture may be a field or a frame (typically consisting of two interleaved fields) comprising a number of macroblocks constituted with a number of pixel blocks. Each pixel block comprises a number of pixels.

Blocking unfortunately is an artifact that can be seen in the final decoded pictures/images for virtually all block based encoding/decoding. In Loop Deblocking filters or Post Processing Deblocking Filters or Matched Post Process Smoothening Filters have been developed to reduce these artifacts. Typically, these techniques involve first using 1 D filters to “smoothen” the pixels across a block edge. The filtered pixels across a block edge are then truncated to an original bit depth of the Image/Video. Due to uniform truncation, the block edges (16×16, 8×8, 4×4, etc) are still visible (artifact) in the final picture/image as a constant difference between the corresponding adjacent pixel blocks.

Thus, it will be desirable to be able to further reduce the blocking artifact in the final pictures/images of a video that have undergone block based encoding and decoding.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of an encoder equipped with an in-loop deblocking filter incorporated with the dithering teachings of the present invention, in accordance with one embodiment;

FIG. 2 illustrates the operational flow of the relevant aspects of the deblocking filter with dithering of FIG. 1, in accordance with one embodiment;

FIG. 3 illustrates two pairs of adjacent pixel blocks where the pixel blocks in one case have a horizontal, and in another case, a vertical relative disposition to each other, in accordance with one embodiment;

FIG. 4 illustrates a data structure view of the pixels of two adjacent pixel blocks, irrespective of the relative disposition of the pixel blocks, in accordance with one embodiment;

FIG. 5a-5b illustrate two overviews of two decoders, one equipped with a deblocking filter incorporated with the dithering teachings of the present invention and another equipped with a post-processing deblocking filter supplemented with dithering, in accordance with two embodiments;

FIG. 5c illustrates a standalone post-processing dithering block for practicing the present invention, in accordance with another alternate embodiment;

FIG. 6 illustrates a video device having an encoder and a decoder incorporated with the encoding/decoding teachings of the present invention, in accordance with one embodiment;

FIG. 7 illustrates an article of manufacture with a recordable medium having a software implementation of the encoder/decoder of the present invention, designed for use to program a device to equip the device with the encoding/decoding capability of the present invention, in accordance with one embodiment; and

FIG. 8 illustrates a system having a video sender device and a video receiver device incorporated with the encoding/decoding teachings of the present invention, in accordance with one embodiment.

### DETAILED DESCRIPTION OF EMBODIMENTS OF THE INVENTION

The present invention includes a block based encoder with or without an in-loop deblocking filter, a complementary decoder, a standalone post-processing dithered deblocking and/or dithering block, devices equipped with these encoders, decoders and/or standalone post-processing dithered deblocking/dithering blocks, systems made up of such devices, and methods of operations of these elements, devices and systems, and related subject matters.

In the following description, various embodiments will be described, starting with an integrated in-loop deblocking filter embodiment, followed by other embodiments, including post-processing and standalone embodiments. For each of these embodiments and their variants, various aspects of the present invention will be described. However, it will be apparent to those skilled in the art that the present invention may be practiced with only some or all aspects of the present invention.

For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

### Terminology

Parts of the description will be presented in video encoding and decoding terms consistent with the manner commonly employed by those skilled in the art to convey the substance of their work to others skilled in the art. These common video encoding and decoding terms are well understood by those skilled in the art. In particular, in a video device, data and control quantities may take the form of electrical, magnetic, or optical signals capable of being stored, transferred, combined, and otherwise manipulated through electrical and/or optical components of a processor, and its subsystems.

In various video encoding/decoding standards, encodings are organized in accordance with certain syntactical rules, thus they are also referred to as “syntax elements” at times.

### Section Headings, Order of Descriptions and Embodiments

Section headings are merely employed to improve readability, and they are not to be construed to restrict or narrow the present invention.

Various operations will be described as multiple discrete steps in turn, in a manner that is helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

### Encoder

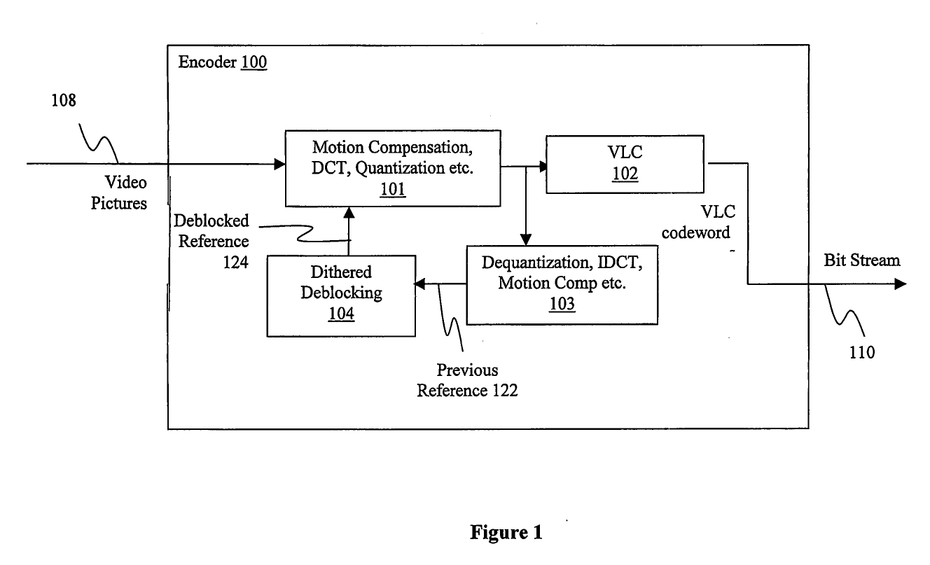

FIG. 1 illustrates an overview of an encoder equipped with an integrated in-loop deblocking filter incorporated with the teachings of the present invention, in accordance with one embodiment. As illustrated, for the embodiment, encoder 100 includes transformation/processing block 101, variable length coding (VLC) block 102, and inverse transformation/processing block 103, and integrated in-loop deblocking filter 104, coupled to each other and to input 108 as shown, to receive pictures of a video. Pixels of the pictures are organized in blocks, which in turn are organized into among others, macroblocks. In response, elements 101-104 cooperate to encode the pictures in a block based manner, and output the encodings into a bit stream at output 110.

Integrated in-loop deblocking filter 104 is employed to perform a deblocking filtering operation on reference pictures 122 output by inverse transformation/processing block 103, to provide transformation/processing block 101 with deblocking filtered reference pictures 124. Under the present invention, integrated in-loop deblocking filter 104 is advantageously equipped with dithering capabilities, more specifically, for the embodiment, dithering tables and complementary logic, to dither one or more pixels across a common block edge of two adjacent pixel blocks of a reference picture 122, as an integral part of the deblocking filtering operation being performed on the reference picture 122. Resultantly, residual block artifacts in each of the deblocking filtered reference pictures 124 are further reduced. In turn, the quality of the pictures, when decoded, is further improved.

More specifically, in various embodiments, pixels across common block edges of various adjacent pixel blocks of a reference picture are dithered before they are down shifted or truncated to the original bit depth, during the deblocking filtering operation.

Except for the novel integration of dithering into the integrated in-loop deblocking filtering operation, to be described more fully below, in-loop deblocking filter 104 may otherwise be implemented in any one of a number of techniques known in the art or to be designed.

Similarly, transformation/processing block 101 and inverse transformation/processing 103 may be implemented in any one of a number of techniques known in the art or to be designed. For example, in various embodiments, transformation/processing block 101 may comprise motion compensation (using deblocking filtered reference pictures 124 with reduced residual block artifact), discrete cosine transformation (DCT), quantization processing and so forth. Complementarily, inverse transformation/processing block 103 may comprise like kind of dequantization, inverse discrete cosine transformation (IDCT), motion compensation processing and so forth.

VLC block 102 may comprise a number of codeword tables having VLC codewords and complementary logic for encoding various aspects of the pictures. For example, the codeword tables may comprise tables of VLC codewords for encoding the macroblock types of the macroblocks of the pictures, transform coefficients, and so forth. The complementary logic may also select and employ the VLC codeword tables in a context adaptive manner.

In various embodiments, the context adaptive encoding of macroblock types may be performed as described in co-pending application Ser. No. ______, entitled “Context Adaptive Macroblock Type Encoding/Decoding Methods and Apparatuses”, filed contemporaneously.

In various embodiments, the context adaptive encoding of transform coefficients may be performed as described in co-pending application Ser. No. 10/232,337, entitled “Context Adaptive Transform Coefficient Encoding/Decoding Methods and Apparatuses”, filed on Aug. 30, 2002.

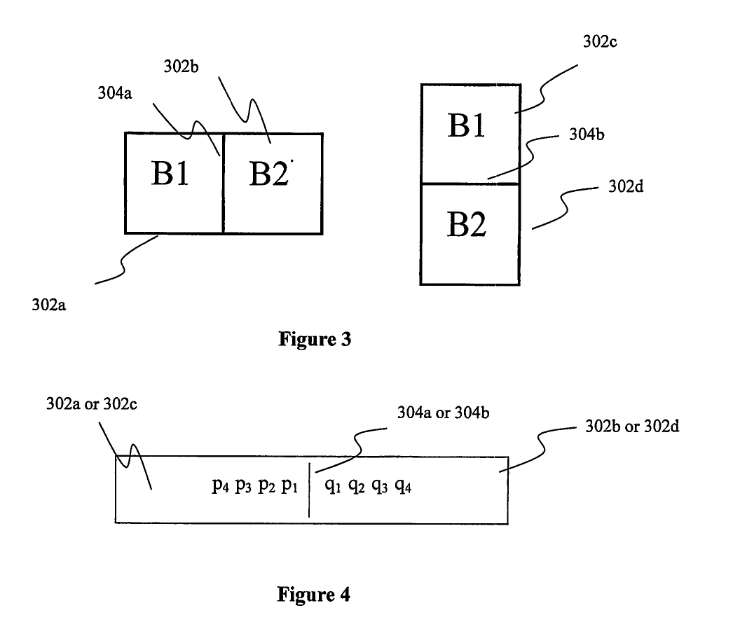

Referring now to FIG. 3, as illustrated, in various embodiments, the earlier described dithering performed as integral part of the deblocking filtering operation is performed on one or more pixels across common block edges of pixel blocks of a macroblock that are adjacent to each other in an horizontal as well as in a vertical relative disposition. Common block edge 304a is an example of a common block edge of pixel blocks 302a and 302b that are adjacent to each other in an horizontal relative disposition. Whereas, common block edge 304b is an example of a common block edge of pixel blocks 302c and 302d that are adjacent to each other in a vertical relative disposition.

In alternate embodiments, the dithering operations may be performed on one or more pixels of pixel blocks coincident on motion compensation block boundaries, transform block boundaries, or other block boundaries, vertically and/or horizontally relative to each other.

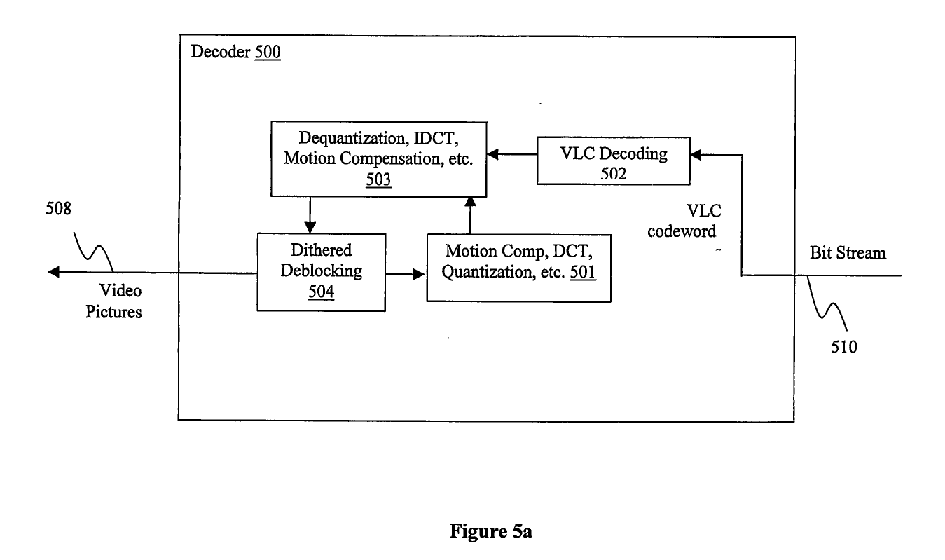

Referring now to FIG. 4, a data structure view of the pixels of two adjacent pixel blocks, in accordance with one embodiment, is illustrated. The further description of the integral dithering process to follow assumes this view of logical organization of the pixels across the common block edge of two pixel blocks, irrespective of the pixel blocks' relative disposition. As shown, for the integral dithering process purpose, the pixels immediately adjacent to the common block edge of a pair of adjacent pixel blocks are referred to as p₁ and q₁. The pixels immediately adjacent to p₁ and q₁ that are one degree removed from the common block edge are referred to as p₂ and q₂. The pixels immediately adjacent to p₂ and q₂ that are two degrees removed away from the common block edge are referred to as p₃ and q₃. The pixels immediately adjacent to p₃ and q₃ that are three degrees removed away from the common block edge are referred to as p₄ and q₄.

In various embodiments, pixels across a common block edge are dithered by 1 intensity level difference. Operationally, the pixels are dithered by 1 least significant bit (LSB).

In various embodiments, a pair of complementary pixels across a common block edge of two adjacent pixel blocks is dithered, based at least in part on pixels up to two degrees removed in either side of each of the pixels.

In various embodiments, a pair of complementary pixels across a common block edge of two adjacent pixel blocks is dithered, by applying a pixel positional dependent variable offset to each of the pixels.

More specifically, in one embodiment, the complementary pixels across a common block edge of two adjacent pixel blocks is dithered as follows:
P₁=(25*p₃+26*p₂+26*p₁+26*q₁+25*q₂+D1)/128
Q₁=(25*p₂+26*p₁+26*q₁+26*q₂+25*q₃+D2)/128
P₂=(25*p₄+26*p₃₊₂₆*p₂₊₂₆*p₁+25*q₁+D1)/128
Q₂=(25*p₁+26*Q₁+26*q₂+26*q₃+25*q₄+D2)/128
and for luma samples,
   P₃=(26*p₄+51*p₃+26*P₂+25*P₁+64)/128
   Q₃=(25*Q₁+26*Q₂+51*q₃+26*q₄+64)/128
where P₁, P₂, P₃, P₄ and Q₁, Q₂, Q₃, Q₄ are the dithered versions of p₁, p₂, p₃, p₄ and q₁, q₂, q₃, q₄ respectively, and
D₁ and D₂ are pixel positional dependent variable offset dithering values.

In varrious embodiments, the appropriate D₁ and D₂ values pre-calculated to be random and to preserve the energy of the original signal.

In various embodiments, D₁ and D₂ are looked up from two dithering value tables. The look up are performed based on the least significant nibble of the X or Y coordinate value of the pixel being dithered.

In various embodiments, the two dithering value tables from which D₁ and D₂ are looked up are
Table I={64, 80, 32, 96, 48, 80, 64, 48, 80, 64, 80, 48, 96, 32, 80, 64}, and
Table II={64, 48, 96, 32, 80, 48, 48, 64, 64, 64, 80, 48, 32, 96, 48, 64}.

In alternate embodiments, the present invention may be practiced with dithering tables of different sizes and/or different dithering values. The present invention may also be practiced with different dithering computations, involving more or less neighboring pixels, with the neighboring pixels given different “weights”.

In alternate embodiments, the dithering values, as opposed to being looked up from dithering tables of pre-computed values, may be computed real time during operation instead. Further, the dithering, as opposed to being performed on a complementary pair of pixels, may be performed on a single pixel or other grouping of pixels instead.

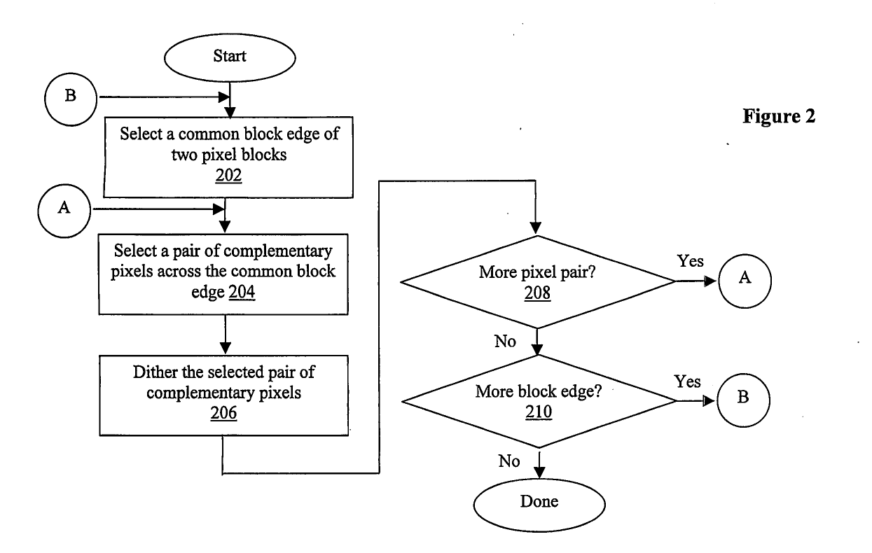

Referring now to FIG. 2, the operational flow of the relevant aspects of integrated in-loop deblocking filter 104 with integral dithering, in accordance with one embodiment, is illustrated. As shown, for the dithering of pixels of adjacent pixel blocks with a common block edge, the process starts at block 202 with the integral dithering logic of in-loop deblocking filter 104 selecting a common block edge of two adjacent pixel blocks. At block 204, the integral dithering logic of in-loop deblocking filter 104 selects one or more pixels across the selected common block edge to dither. In one embodiment, the integral dithering logic of in-loop deblocking filter 104 selects a pair of complementary pixels across the selected common block edge to dither.

At block 206, the integral dithering logic of in-loop deblocking filter 104 dithers the selected pair of complementary pixels across the selected common block edge. In various embodiments, the integral dithering logic of in-loop deblocking filter 104 dithers the selected pair of complementary pixels across the selected common block edge using the above described dithering formulas and dithering tables. As alluded to earlier, in alternate embodiments, the integral dithering logic of in-loop deblocking filter 104 generates the dithering values in real time. Again, in either case, the dithering values may be random or pseudo-random.

At block 208, the integral dithering logic of in-loop deblocking filter 104 determines if pixels to be dithered across the selected common block edge has been dithered. If not, the process continues back at block 204, else the process continues at block 210.

At block 210, the integral dithering logic of in-loop deblocking filter 104 determines if dithering for all common block edges has been dithered. If not, the process continues back at block 202, else the process terminates.

Referring back briefly to FIG. 1, in various embodiments, encoder 100 including transformation/processing block 101, VLC block 102, inverse transformation/processing block 103 and in-loop deblocking filter 104 may be implemented in hardware, e.g. via application specific integrated circuit (ASIC), or in software, e.g. in programming languages such as C, or a combination of both.

### Decoder

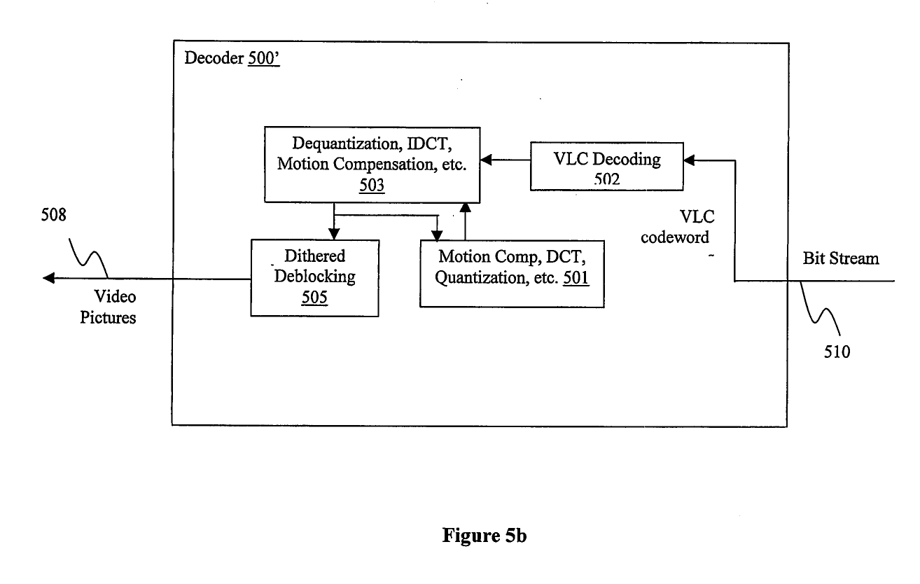

FIG. 5a illustrates an overview of a decoder of the present invention with the in-loop deblocking filter complementarily equipped as the earlier described encoder of FIG. 1, in accordance with one embodiment. As illustrated, for the embodiment, decoder 500 is similarly constituted as encoder 100 having VLC decoding block 502, inverse transformation/processing block 503, integrated in-loop deblocking filter 504 and transformation/processing block 501. Elements 501-504 are coupled to each other and to input 510 as shown, to receive a bit stream comprising VLC codewords encoding the pictures of a video in a block based manner, including having the deblocking filtering operation performed on the previous reference pictures with dithering as earlier described.

For each macroblock of pixel blocks, VLC decoding block 502 decodes the various VLC encodings to contribute towards reconstituting the pictures. Inverse transformation/processing block 503 performs dequantization, IDCT, motion compensation etc. to contribute to reverse processing the decoded pictures back to their original states. Integrated in-loop deblocking filter 504 performs in-loop deblocking with dithering, as earlier described, on the recovered pictures 522, before outputting them as the “final” reconstituted pictures. In other words, under the present invention, for the integrated in-loop embodiment, the outputted “final” reconstituted pictures are the same deblocking filtered and dithered reference pictures of the encoding processing.

For the embodiment, integrated in-loop deblocking filter 504 also provides the deblocking filtered and dithered pictures to inverse transformation/processing block 503. Transformation/processing block 501 performs motion compensation, DCT, quantization, etc. to condition them for use by inverse transformation/processing block 501 as previous reference pictures.

In various embodiments, integrated in-loop deblocking filter 504 with dithering is similarly constituted as integrated in-loop deblocking filter 104 with dithering. That is, the two deblocking filters 104 and 504 apply the same dithering computations, i.e. employing the same tables of dithering values, or generating the dithering values in real time. In various embodiments, the dithering computations and the tables of dithering values are the earlier formulas and tables.

Similarly, in various embodiments, transformation/processing block 501, VLC decoding 502, and inverse transformation/processing block 503 are all similarly constituted as transformation/processing block 101, VLC coding 102, and inverse transformation/processing block 103.

In various embodiments, decoder 500 including transformation/processing block 501, VLC decoding block 502, inverse transformation/processing block 503 and in-loop deblocking filter with dithering 504 may be implemented in hardware, e.g. via application specific integrated circuit (ASIC), or in software, e.g. in programming languages such as C, or a combination of both.

As with the earlier described encoder, in alternate embodiments, the dithering operation may be performed on single pixel, as well as other grouping of pixels instead. Whether the dithering operation is performed on single pixels, complementary pixel pairs or other grouping of pixels, the single or grouping of pixels, in addition to being pixels coincident with macroblock boundaries, they may be pixels coincident with motion compensation block boundaries, transform block boundaries, or the boundary of any other block of pixels that are processed together.

FIG. 5b illustrates an overview of another decoder, where the dithering capability is provided via a post-processing dithered deblocking block, in accordance with another embodiment. In this embodiment, the dithering capability (instead of being integrated with an in-loop deblocking filter 504) is provided as a post-processing dithered deblocking block 505, as shown. Post-processing dithered deblocking block 505 performs dithered deblocking on outputs of inverse transformation/processing block 503 as earlier described, and the dithered outputs are outputted as the final outputs, without also being fed back to motion compensation/quantization block 501.

As with the embodiment of FIG. 5a, dithering may be performed on single, complementary pair or other group of pixels, coincident on maroblock boundaries, motion compensation block boundaries, transform block boundaries, or boundaries of other blocks of pixels that are processed together.

The dithering values may be looked up (i.e. pre-computed) or computed real time. The dithering values may be randomly or pseudo-randomly computed.

FIG. 5c illustrates an overview of a standalone dithering block, in accordance with another embodiment. In this embodiment, the dithering capability (instead of being integrated with decoder 500) is provided as a standalone dithering block 507, coupled to deblocking filter 506 of decoder 500, as shown. Post-processing dithering block 507 performs dithering on outputs of deblocking filter 506 as earlier described, and the dithered outputs are outputted as the final outputs.

As with the embodiments of FIGS. 5a and 5b, dithering may be performed on single, complementary pair or other group of pixels, coincident on maroblock boundaries, motion compensation block boundaries, transform block boundaries, or boundaries of other blocks of pixels that are processed together.

The dithering values may be looked up (i.e. pre-computed) or computed in line. The dithering values may be randomly or pseudo-randomly computed.

### Example Applications of the Present Invention

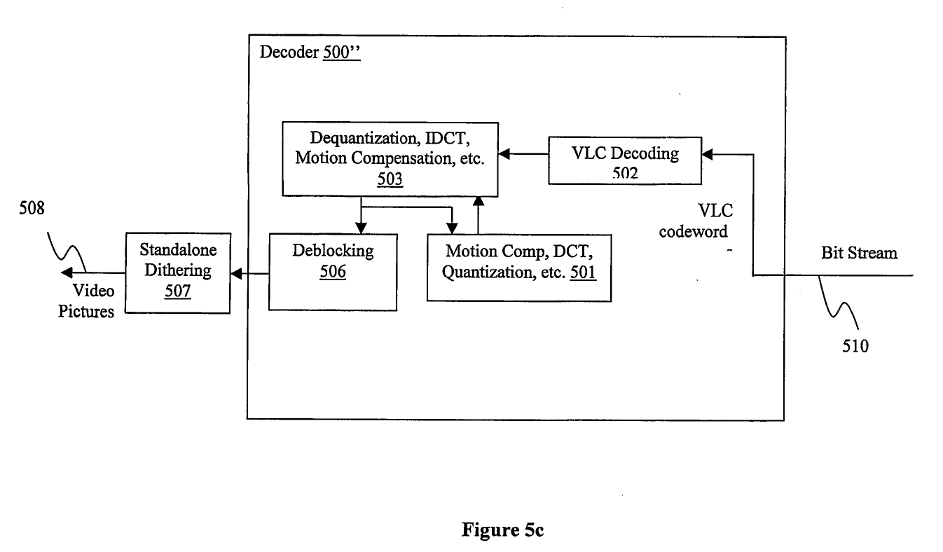

FIG. 6 illustrates a video device incorporated with the teachings of the present invention, in accordance with one embodiment. As illustrated, video device 600 includes encoder 610 and decoder 620 coupled to the inputs and outputs of the device. As described earlier, encoder 610 is designed to receive pictures of a video, and encode them in response, into VLC codewords 634a, including integral performance of dithering of pixels across common block edges during deblocking filtering of the previous reference pictures. Decoder 620 is designed to receive VLC codewords 634b of pictures of another video, and to decode in response the codewords, and reconstitute the original pictures 632b.

Encoder 610 and decoder 620 are similarly constituted as the earlier described encoder 100 and decoder 500. In various embodiments, encoder 610 and decoder 620 may share at least in part their in-loop deblocking filters (as denoted by the intersecting blocks of encoder 610 and decoder 620). In various embodiments, they may also share their codewords tables and coding/decoding logics, as well as other components.

In various embodiments, video device 600 may be a wireless mobile phone, a palm sized computing device, such as a personal digital assistant, a laptop computing device, a desktop computing device, a server, and other computing devices of the like. In other embodiments, video device 600 may be a circuit board component, such as a video “add-on” circuit board (also referred to as a daughter circuit board), a motherboard, and other circuit boards of the like.

In yet other embodiments, video device 600 may comprise encoder 610 only, as in the case of a digital camera, or decoder 620 only, as in the case of a DVD player, a set-top box, a television or a display monitor.

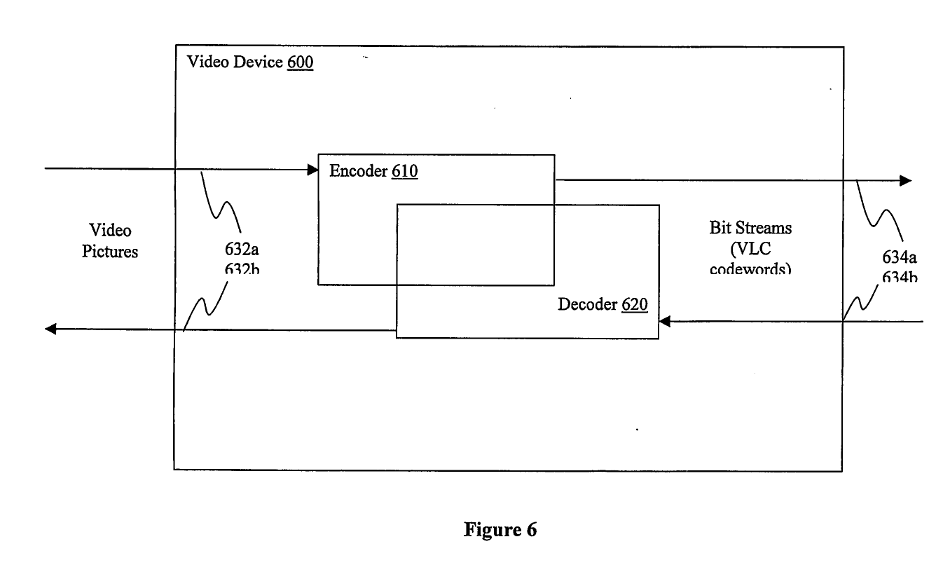

FIG. 7 illustrates an article of manufacture including a recordable medium 700 having programming instructions implementing a software embodiment of the earlier described encoder 100 and/or decoder 500. Programming instructions implementing a software embodiment of encoder 100 and/or decoder 500 are designed for use to program video device 710 to equip video device 710 with the encoding and decoding capabilities of the present invention.

For the embodiment, video device 710 include storage medium 712 to store at least a portion of a working copying of the programming instructions implementing the software embodiment of encoder 100 and/or decoder 500, and at least one processor 714 coupled to storage medium 712 to execute the programming instructions.

Video device 712 may be any one of the earlier enumerated example device devices or other video devices of the like. Article 710 may e.g. be a diskette, a compact disk (CD), a DVD or other computer readable medium of the like. In other embodiments, article 710 may be a distribution server distributing encoder 100 and/or decoder 500 on line, via private and/or public networks, such as the Internet. In one embodiment, article 710 is a web server.

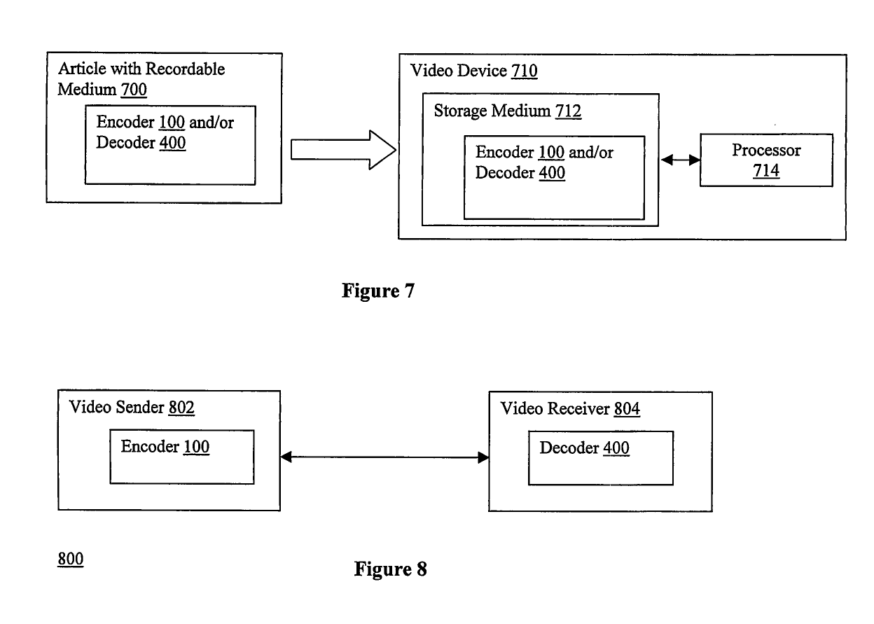

FIG. 8 illustrates an example system having video sender 802 and video receiver 804 communicatively coupled to each other as shown, with video sender 802 encoding a video in accordance with the teachings of the present invention, and providing the encoded video to video receiver 802, and video receiver 802, in turn decoding the encoded video to render the video. Video sender 802 and video receiver 804 are equipped with the earlier described encoder 100 and decoder 500 respectively.

An example of video sender 802 is a video server, whereas an example of a video receiver 804 is a client device coupled to video sender 802.

### Conclusion and Epilogue

Thus, it can be seen from the above descriptions, a novel method for deblocking block based encoded pictures, including encoders, decoders, standalone dithering blocks, devices and systems incorporated with these elements, and method practiced thereon, have been described.

While the present invention has been described in terms of the foregoing embodiments and example applications, those skilled in the art will recognize that the invention is not limited to the embodiments and example application described. The present invention can be practiced with modification and alteration within the spirit and scope of the appended claims. For examples, different number of encoder/decoder blocks, different number of codeword tables in the various encoder/decoder blocks, different codeword tables, and different codeword table selection logic.

Thus, the description is to be regarded as illustrative instead of restrictive on the present invention.

1. An apparatus comprising:
storage medium having stored therein
a selected one of
a plurality of dithering tables, with each of said plurality of dithering tables having a plurality of dithering values, and
a first plurality of programming instructions to generate the dithering values, and
a second plurality of programming instructions designed to perform deblocking filtering on pixel blocks of a picture, and employing the dithering values to dither one or more pixels of two pixel blocks across a common block edge of the two pixel blocks; and
at least one processor coupled to the storage medium to execute said programming instructions.

2. The apparatus of claim 1, wherein the two pixel blocks are vertically related to each other, and the common block edge comprises a common horizontal block edge.

3. The apparatus of claim 1, wherein the two pixel blocks are horizontally related to each other, and the common block edge comprises a common vertical block edge.

4. The apparatus of claim 1, wherein the dithering values of the dithering tables are designed to be accessed by the second programming instructions in a pixel position dependent manner, and the second programming instructions are designed to so access the dithering values of the dithering tables.

5. The apparatus of claim 1, wherein the plurality of dithering tables comprises at least a selected one of
a first dithering table having 16 ordered dithering values of {64, 80, 32, 96, 48, 80, 64, 48, 80, 64, 80, 48, 96, 32, 80, 64}, and
a second dithering table having 16 ordered dithering values of {64, 48, 96, 32, 80, 48, 48, 64, 64, 64, 80, 48, 32, 96, 48, 64}.

6. The apparatus of claim 1, wherein the second plurality of programming instructions are deigned to dither a pixel based at least in part on pixels immediately adjacent to and one degree removed from the pixel in either side of the pixel.

7. The apparatus of claim 6, wherein the second plurality of programming instructions are designed to dither at least one of two pixels (p₁, q₁) of the two pixel blocks that are immediately adjacent to the common block edge in accordance with a corresponding formula, as follows:
P₁=(25*p₃+26*p₂+26*p₁+26*q₁+25*q₂+D1)/128
Q₁=(25*p₂+26*p₁+26*q₁+26*q₂+25*q₃+D2)/128
where P₁ and Q₁ are the dithered versions of p₁, q₁ respectively,
p₂ and q₂ are immediately adjacent to p₁ and q₁, and one degree removed from the common block edge,
p₃ and q₃ are immediately adjacent to p₂ and q₂, and two degrees removed from the common block edge,
D₁ and D₂ are dithering values.

8. The apparatus of claim 6, wherein the second plurality of programming instructions are designed to dither at least one of two pixels (p₂, q₂) of the two pixel blocks that are one degree removed from the common block edge in accordance with a corresponding formula, as follows
P₂=(25*p₄+26*p₃+26*p₂+26*P₁+25*q₁+D1)/128
Q₂=(25*p₁+26*Q₁+26*q₂+26*q₃+25*q₄+D2)/128
where P₂ and Q₂ are the dithered versions of p₂, q₂ respectively,
P₁ and Q₁ are dithered versions of p₁, q₁ respectively, which are pixels immediately adjacent to p₂ and q₂ respectively, and to the common block edge,
p₃ and q₃ are immediately adjacent to p₂ and q₂ respectively, and two degrees removed from the common block edge,
p₄ and q₄ are immediately adjacent to p₃ and q₃ respectively, and three degrees removed from the common block edge, and
D₁ and D₂ are dithering values.

9. The apparatus of claim 6, wherein the second plurality of programming instructions are designed to dither at least one of two pixels (p₃, q₃) of the two pixel blocks that are two degrees removed from the common block edge in accordance with a corresponding formula, as follows
P₃=(26*p₄+51*p₃+26*P₂+25*P₁+64)/128
Q₃=(25*Q₁+26*Q₂+51*q₃+26*q₄+64)/128
where P₃ and Q₃ are the dithered versions of p₃, q₃ respectively,
P₂ and Q₂ are dithered versions of p₂, q₂ respectively, which are pixels immediately adjacent to p₃ and q₃ respectively, and one degree removed from the common block edge,
P₁ and Q₁ are dithered versions of p₁, q₁ respectively, which are pixels immediately adjacent to p₂ and q₂ respectively, and to the common block edge, and
p₄ and q₄ are immediately adjacent to p₃ and q₃ respectively, and
three degrees removed from the common block edge.

10. The apparatus of claim 1, wherein
the storage medium further having stored there in a plurality codeword tables, with each of the codeword tables having a plurality of codewords; and
a third plurality of programming instructions designed to encode one or more aspects of a macroblock of the picture comprising the two pixel blocks.

11. The apparatus of claim 1, wherein
the storage medium further having stored there in a plurality codeword tables, with each of the codeword tables having a plurality of codewords; and
a third plurality of programming instructions designed to decode one or more encoded aspects of a macroblock of the picture comprising the two pixel blocks.

12. The apparatus of claim 1, wherein the apparatus comprises a selected one of a palm sized computing device, a wireless mobile phone, a digital personal assistant, a laptop computing device, a desktop computing device, a set-top box, a server, a compact disk player, a digital versatile disk player, a television, and a display monitor.

13. The apparatus of claim 1, wherein the apparatus comprises a video daughter card and a motherboard having integrated video capability.

14. An article of manufacture comprising:
a recordable medium;
a selected one of
a plurality of dithering tables, recorded on the recordable medium to be loaded into an apparatus, with each of said plurality of dithering tables having a plurality of dithering values, and
a first plurality of programming instructions to generate the dithering values real time, and
a second plurality of programming instructions, also recorded on the recordable medium and to be loaded into the apparatus, to enable the apparatus to perform deblocking filtering on a picture, and employing the dithering values to dither one or more pixels across block edges of pixel blocks of the picture.

15. The article of claim 14, wherein the dithering values of the dithering tables are designed to be accessed by the second programming instructions in a pixel position dependent manner, and the second programming instructions are designed to so access the dithering values of the dithering tables.

16. The article of claim 14, wherein the plurality of dithering tables comprises at least a selected one of
a first dithering table having 16 ordered dithering values of {64, 80, 32, 96, 48, 80, 64, 48, 80, 64, 80, 48, 96, 32, 80, 64}, and
a second dithering table having 16 ordered dithering values of {64, 48, 96, 32, 80, 48, 48, 64, 64, 64, 80, 48, 32, 96, 48, 64}.

17. The article of claim 14, wherein the second plurality of programming instructions are deigned to dither a pixel based at least in part on pixels immediately adjacent to and one degree removed from the pixel in either side of the pixel.

18. The article of claim 14, wherein the second plurality of programming instructions are designed to dither at least one of two pixels (p₁, q₁) of the two pixel blocks that are immediately adjacent to the common block edge in accordance with a corresponding formula, as follows:
P₁=(25*p₃+26*p₂+26*p₁+26*q₁+25*q₂+D1)/128
Q₁=(25*p₂+26*p₁+26*q₁+26*q₂+25*q₃+D2)/128
where P₁ and Q₁ are the dithered versions of p₁, q₁ respectively,
p₂ and q₂ are immediately adjacent to p₁ and q₁, and one degree removed from the common block edge,
p₃ and q₃ are immediately adjacent to p₂ and q₂, and two degrees removed from the common block edge,
D_{1 and D}₂ are dithering values.

19. The article of claim 14, wherein the second plurality of programming instructions are designed to dither at least one of two pixels (p₂, q₂) of the two pixel blocks that are one degree removed from the common block edge in accordance with a corresponding formula, as follows
P₂=(25*p₄+26*p₃+26*p₂+26*P₁+25*q₁+D1)/128
Q₂=(25*p₁+26*Q₁+26*q₂+26*q₃+25*q₄+D2)/128
where P₂ and Q₂ are the dithered versions of p₂, q₂ respectively,
P₁ and Q₁ are dithered versions of p₁, q₁ respectively, which are pixels immediately adjacent to p₂ and q₂ respectively, and to the common block edge,
p₃ and q₃ are immediately adjacent to p₂ and q₂ respectively, and two degrees removed from the common block edge,
p₄ and q₄ are immediately adjacent to p₃ and q₃ respectively, and three degrees removed from the common block edge, and
D₁ and D₂ are dithering values.

20. The article of claim 14, wherein the second plurality of programming instructions are designed to dither at least one of two pixels (p₃, q₃) of the two pixel blocks that are two degrees removed from the common block edge in accordance with a corresponding formula, as follows
P₃=(26*p₄+51*p₃+26*P₂+25*P₁+64)/128
Q₃=(25*Q₁+26*Q₂+51*q₃+26*q₄+64)/128
where P₃ and Q₃ are the dithered versions of p₃, q₃ respectively,
P₂ and Q₂ are dithered versions of p₂, q₂ respectively, which are pixels immediately adjacent to p₃ and q₃ respectively, and one degree removed from the common block edge,
P₁ and Q₁ are dithered versions of p₁, q₁ respectively, which are pixels immediately adjacent to p₂ and q₂ respectively, and to the common block edge, and
p₄ and q₄ are immediately adjacent to p₃ and q₃ respectively, and three degrees removed from the common block edge.

21. The article of claim 14, wherein
the recordable medium further having recorded a plurality codeword tables to be loaded into the apparatus, with each of the codeword tables having a plurality of codewords; and
a third plurality of programming instructions designed to enable the apparatus to encode one or more aspects of a macroblock of the picture comprising the two pixel blocks.

22. The article of claim 14, wherein
the recordable medium further having recorded a plurality codeword tables to be loaded into the apparatus, with each of the codeword tables having a plurality of codewords; and
a third plurality of programming instructions designed to enable the apparatus to decode one or more encoded aspects of a macroblock of the picture comprising the two pixel blocks.

23. A video encoding/decoding method comprising:
selecting a common block edge of two pixel blocks of a picture having a deblocking filtering operation being performed or performed;
selecting one or more pixels across the common block edge of the two pixel blocks; and
applying one or more dithering values to values of the selected one or more pixels across the common block edge to dither the selected one or more pixels.

24. The method of claim 23, wherein the method further comprises accessing one or more dithering tables of dithering values in a pixel position dependent manner to retrieve the dithering values employed.

25. The method of claim 23, wherein said accessing comprises accessing at least a selected one of
a first dithering table having 16 ordered dithering values of {64, 80, 32, 96, 48, 80, 64, 48, 80, 64, 80, 48, 96, 32, 80, 64}, and
a second dithering table having 16 ordered dithering values of {64, 48, 96, 32, 80, 48, 48, 64, 64, 64, 80, 48, 32, 96, 48, 64}.

26. The method of claim 23, wherein said dithering comprises dithering a pixel based at least in part on pixels immediately adjacent to and one degree removed from the pixel in either side of the pixel.

27. The method of claim 26, wherein said dithering comprises dithering at least a selected one of two pixels (p₁, q₁) of the two pixel blocks that are immediately adjacent to the common block edge in accordance with a corresponding formula, as follows:
P₁=(25*p₃+26*p₂+26*p₁+26*q₁+25*q₂+D1)/128
Q₁=(25*p₂+26*p₁+26*q₁+26*q₂+25*q₃+D2)/128
where P₁ and Q₁ are the dithered versions of p₁, q₁ respectively,
p₂ and q₂ are immediately adjacent to p₁ and q₁, and one degree removed from the common block edge,
p₃ and q₃ are immediately adjacent to p₂ and q₂, and two degrees removed from the common block edge, and
D₁ and D₂ are dithering values.

28. The method of claim 26, wherein said dithering comprises dithering at least one of two pixels (p₂, q₂) of the two pixel blocks that are one degree removed from the common block edge in accordance with a corresponding formula as follows
P₂=(25*p₄+26*p₃+26*p₂+26*P₁+25*q₁+D1)/128
Q₂=(25*p₁+26*Q₁+26*q₂+26*q₃+25*q₄+D2)/128
where P₂ and Q₂ are the dithered versions of p₂, q₂ respectively,
P₁ and Q₁ are dithered versions of p₁, q₁ respectively, which are pixels immediately adjacent to p₂ and q₂ respectively, and to the common block edge,
p₃ and q₃ are immediately adjacent to p₂ and q₂ respectively, and two degrees removed from the common block edge,
p₄ and q₄ are immediately adjacent to p₃ and q₃ respectively, and three degrees removed from the common block edge, and
D₁ and D₂ are dithering values.

29. The method of claim 26, wherein said dithering comprises dithering at least a selected one of two pixels (p₃, q₃) of the two pixel blocks that are two degrees removed from the common block edge in accordance with a corresponding formula, as follows
P₃=(26*p₄+51*p₃+26*P₂+25*P₁+64)/128
Q₃=(25*Q₁+26*Q₂+51*q₃+26*q₄+64)/128
where P₃ and Q₃ are the dithered versions of p₃, q₃ respectively,
P₂ and Q₂ are dithered versions of p₂, q₂ respectively, which are pixels immediately adjacent to p₃ and q₃ respectively, and one degree removed from the common block edge,
P₁ and Q₁ are dithered versions of p₁, q₁ respectively, which are pixels immediately adjacent to p₂ and q₂ respectively, and to the common block edge, and
p₄ and q₄ are immediately adjacent to p₃ and q₃ respectively, and three degrees removed from the common block edge.

30. The method of claim 23, wherein the method further comprises
accessing a plurality codecode tables to retrieve one or more codewords; and
encode one or more aspects of a macroblock of the picture comprising the two pixel blocks, using the retrieved one or more codewords.

31. The method of claim 23, wherein the method further comprises
accessing a plurality codecode tables to retrieve one or more codewords; and
decode one or more encoded aspects of a macroblock of the picture comprising the two pixel blocks, using the retrieved one or more codewords.
